(19) United States
(12) Patent Application Publication
(10) Pub. No.: US 2024/0146858 A1
(43) Pub. Date: May 2, 2024

(54) BILLING CONTROL APPARATUS, BILLING SYSTEM, CONTROL METHOD, AND STORAGE MEDIUM CAPABLE OF PERFORMING BILLING PROCESSING IN RESPONSE TO STATE OF MEDIUM WHEN THERE IS MEDIUM BEFORE PRINTING OR DURING PRINTING AS RESULT OF USER INTENTIONALLY STOPPING PRINTING

(71) Applicant: CANON KABUSHIKI KAISHA, Tokyo (JP)

(72) Inventor: Eisuke Nishitani, Tokyo (JP)

(21) Appl. No.: 18/378,805

(22) Filed: Oct. 11, 2023

(30) Foreign Application Priority Data
Oct. 27, 2022 (JP) 2022-172538

(51) Int. Cl. H04N 1/34

(52) U.S. Cl. CPC H04N 1/346; H04N 1/344

(57) ABSTRACT

A billing control apparatus capable of performing a billing processing in response to a state of a medium before printing or during printing is provided. The billing control apparatus, which manages billing information related to printing based on a print job, includes a job receiving unit that receives the print job, an interruption command receiving unit that receives an interruption command of the print job, and a controller configured or programmed to function as a print starting unit that transmits the received print job to the image printing apparatus and causes the image printing apparatus to start printing based on the print job, a print stopping unit that causes the image printing apparatus to stop the printing upon receiving the interruption command, and a billing setting unit that sets billing information related to the printing based on a feeding state of a medium when the printing is stopped.

### BACKGROUND OF THE INVENTION

### Field of the Invention

The present invention relates to a billing control apparatus, a billing system, a control method, and a storage medium, and particularly relates to a billing control apparatus, a billing system, a control method, and a storage medium that perform billing control with respect to a medium.

### Description of the Related Art

Conventionally, there is a known billing system that stops a printing operation when an abnormality occurs during execution of a print job in a printer, performs a billing processing with respect to printing sheets (media) to be charged (billed) in the device by a billing counter, and cancels the print job (for example, see Japanese Laid-Open Patent Publication (kokai) No. 2007-86423).

On the other hand, in the case of renting or subscribing to a printer, it is common to make a contract including a predetermined billing condition and perform a billing processing based on the billing condition every certain period during which a billing amount is fixed. In addition, as the billing condition, the billing amount is generally set according to a cumulative number of printed pages, a cumulative printed area, and the like within the certain period.

However, according to Japanese Laid-Open Patent Publication (kokai) No. 2007-86423, the billing processing is performed by determining that a paper sheet (a printing sheet) that has been outputted as a printed product is a paper sheet to be charged (billed), and a technical disclosure is not made for a billing processing in a case that a paper sheet during printing or a paper sheet before printing exists inside the device. For this reason, in Japanese Laid-Open Patent Publication (kokai) No. 2007-86423, in the case that a user issues a print stop command to stop printing after a paper sheet has been fed to the printer, the paper sheet before printing or the paper sheet during printing exists inside the device is discharged to the outside of the device without being charged (billed). As a result, a printing service provider who provides paper sheets to the printer needs to bear the cost of unused paper sheets or partially printed paper sheets and the cost of coloring materials used for printing of the partially printed paper sheets.

### SUMMARY OF THE INVENTION

The present invention provides a billing control apparatus, a billing system, a control method, and a storage medium that are capable of performing a billing processing in response to a state of a medium before printing or during printing when there is such a medium as a result of a user intentionally stopping the printing.

Accordingly, the present invention provides a billing control apparatus that is communicably connected to a user terminal and an image printing apparatus and manages billing information related to printing performed by the image printing apparatus based on a print job instructed by a user via the user terminal, the billing control apparatus comprising a job receiving unit configured to receive the print job from the user terminal, an interruption command receiving unit configured to receive an interruption command of the print job instructed by the user from the user terminal, and a controller configured or programmed to function as a print starting unit that transmits the received print job to the image printing apparatus and causes the image printing apparatus to start printing based on the print job, a print stopping unit that causes the image printing apparatus to stop the printing upon receiving the interruption command from the user terminal; and a billing setting unit that sets billing information related to the printing based on a feeding state of a medium in the image printing apparatus when the printing performed by the image printing apparatus is stopped by the print stopping unit.

Accordingly, the present invention provides a billing system comprising a user terminal, an image printing apparatus, and a billing control apparatus that is communicably connected to the user terminal and the image printing apparatus and manages billing information related to printing performed by the image printing apparatus based on a print job instructed by a user via the user terminal. The user terminal comprises a controller configured or programmed to function as a job generating unit that generates the print job based on a user instruction and an interruption command generating unit that generates an interruption command of the print job based on a user instruction, a job transmitting unit that transmits the print job to the billing control apparatus, and an interruption command transmitting unit that transmits the interruption command to the billing control apparatus. The billing control apparatus comprises a controller configured or programmed to function as a print starting unit that, in a case of receiving the print job from the user terminal, transmits the print job to the image printing apparatus and causes the image printing apparatus to start printing based on the print job, a print stopping unit that, in a case of receiving the interruption command from the user terminal, causes the image printing apparatus to stop the printing, and a billing setting unit that sets billing information related to the printing based on a feeding state of a medium when the printing performed by the image printing apparatus is stopped by the print stopping unit.

According to the present invention, in the case that there is a medium before printing or during printing as the result of the user intentionally stopping the printing, it is possible to perform the billing processing in response to the state of the medium.

Further features of the present invention will become apparent from the following description of exemplary embodiments with reference to the attached drawings.

### BRIEF DESCRIPTION OF THE DRAWINGS

FIG. 1 is an overall configuration diagram that shows a billing system according to a first embodiment of the present invention.

FIG. 2 is a diagram that shows a hardware configuration of a printer shown in FIG. 1.

FIG. 3 is a flowchart that shows an operation processing of a server and an operation processing of a user terminal when a user instruction to interrupt a print job is issued according to the first embodiment of the present invention.

FIG. 4 is a flowchart of a billing processing, which is executed by the server shown in FIG. 1 at the time of receiving a print job interruption command according to the first embodiment of the present invention.

FIG. 5 is a flowchart of a billing processing, which is executed by the server, at the time of receiving a print job interruption command according to a second embodiment of the present invention.

FIG. 6 is a flowchart of a billing processing, which is executed by the server, at the time of receiving a print job interruption command according to a third embodiment of the present invention.

### DESCRIPTION OF THE EMBODIMENTS

The present invention will now be described in detail below with reference to the accompanying drawings showing embodiments thereof.

Hereinafter, embodiments will be described with reference to the accompanying drawings. It should be noted that the following embodiments do not limit the invention related to the claims. Although a plurality of features are described in the embodiments, all of the plurality of features are not necessarily essential to the invention, and the plurality of features may be arbitrarily combined. Further, in the accompanying drawings, the same or similar configurations are denoted by the same reference numerals, and redundant description is omitted.

Hereinafter, a first embodiment of the present invention will be described.

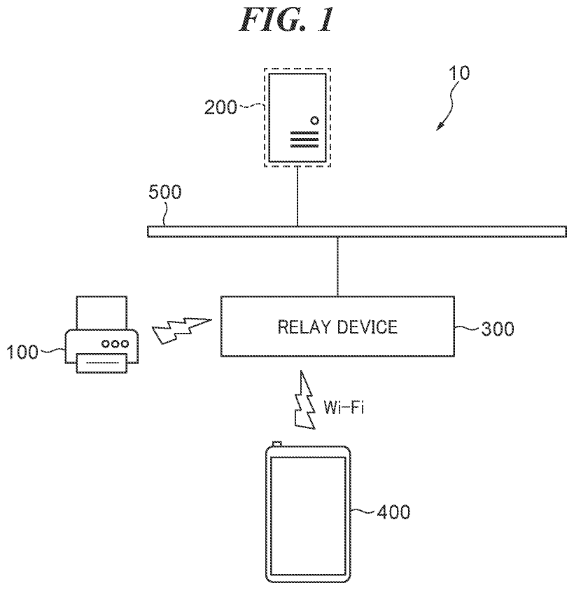

FIG. 1 is an overall configuration diagram of a billing system 10 according to the first embodiment.

The billing system 10 includes a server 200 and a relay device 300 that are connected to a network 500, and a printer 100 and a user terminal 400 that are connected to the relay device 300 via a wireless local area network (LAN) line.

The server 200 (a billing control apparatus) manages print jobs and billing information. A user transmits a print job or a print job interruption command from the user terminal 400 to the server 200 via the relay device 300 and the network 500. With this configuration, the server 200 is able to instruct the printer 100 (an image printing apparatus) to start or stop printing based on the print job.

At the time of completion of the printing based on the received print job or at the time of stopping of the printing according to the print job interruption command, the printer 100 (the image printing apparatus) calculates a usage amount of each contract condition (an ink/toner usage amount, the number of pages used, a printed area) for each job and transmits the calculated usage amount to the server 200.

The server 200 calculates a cumulative usage amount based on the usage amount for each job received from the printer 100, calculates a billing amount regarding the user, and stores the billing amount in a nonvolatile memory (not shown) on the server 200 as the billing information.

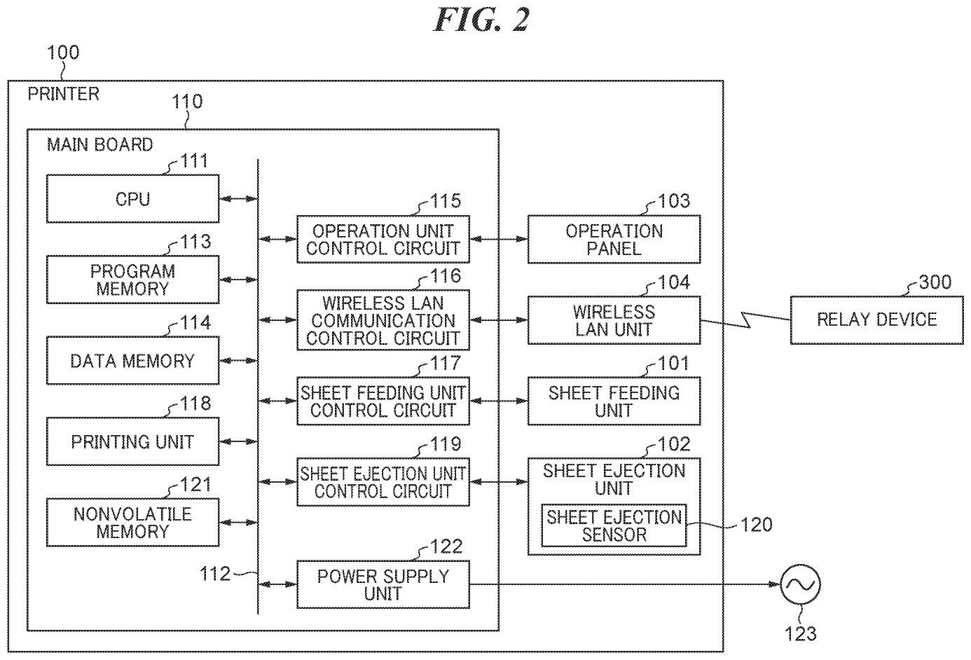

FIG. 2 is a diagram that shows a hardware configuration of the printer 100.

The printer 100 includes a main board 110 that controls the entire device, a sheet feeding unit 101, a sheet ejection unit 102, an operation panel 103, and a wireless LAN unit 104.

The main board 110 includes a central processing unit (CPU) 111, a program memory 113, a data memory 114, an operation unit control circuit 115, a wireless LAN communication control unit (a wireless LAN communication control circuit) 116, a sheet feeding unit control circuit 117, and a printing unit 118. The main board 110 further includes a sheet ejection unit control circuit 119, a nonvolatile memory 121, and a power supply unit 122. Respective components of the main board 110 are connected to each other via an internal bus 112.

The CPU 111 is a microprocessor that operates (runs) according to a control program stored in the program memory 113 in a read only memory (ROM) form and the contents of the data memory 114 in a random access memory (RAM) form. The CPU 111 is able to display the state of the printer 100, display a function selection menu, and accept an operation from the user via the operation panel 103 by controlling the operation unit control circuit 115. In addition, the CPU 111 is able to communicate with the server 200 via the relay device 300 and the network 500 by controlling the wireless LAN unit 104 through the wireless LAN communication control unit 116. When the CPU 111 receives a print job, the CPU 111 (a printing unit) controls the sheet feeding unit control circuit 117 to feed a medium from the sheet feeding unit 101 and convey the medium to the printing unit 118, and controls the printing unit 118 to print an image on the medium sent from the sheet feeding unit 101. Further, the CPU 111 controls the sheet ejection unit control circuit 119 to take in the medium from the printing unit 118 and send the medium to the sheet ejection unit 102. In addition, after the start of printing based on the print job, the CPU 111 (functioning not only a first counting unit but also a second counting unit) counts the number of media for which image printing performed by the printing unit 118 has been completed (the number of print-completed sheets), and counts the number of media fed by the sheet feeding unit 101 (the total number of fed sheets). The counting result of the number of print-completed sheets and the counting result of the total number of fed sheets are stored in the data memory 114, and are sequentially updated until the printing is ended or interrupted.

A sheet ejection sensor 120 is mounted on the sheet ejection unit 102, and is able to detect the state of the medium being ejected.

The nonvolatile memory 121 is configure by a flash memory or the like, and stores data desired to be stored even after the power is turned off.

The power supply unit 122 is connected to an AC commercial power supply 123 to supply power to the printer 100.

It should be noted that although not shown, the server 200 and the user terminal 400 also have a hardware configuration similar to that of the printer 100. Therefore, in the following description of the hardware configuration of the server 200, the numbering of the various hardware configurations of the printer 100 is replaced from the 100s to the 200s (for example, the server 200 includes a CPU 211). Similarly, in the case that the hardware configuration of the user terminal 400 is described, the numbering of the various hardware configurations of the printer 100 is replaced from the 100s to the 400s (for example, the user terminal 400 includes a CPU 411). However, neither the server 200 nor the user terminal 400 includes the configuration unique to the image printing apparatus of the printer 100 (for example, the sheet feeding unit 101, the sheet ejection unit 102, the sheet feeding unit control circuit 117, the printing unit 118, and the sheet ejection unit control circuit 119). In addition, the server 200 includes a communication control unit 216 connected to the network 500 instead of the wireless LAN unit 104 and the wireless LAN communication control unit 116.

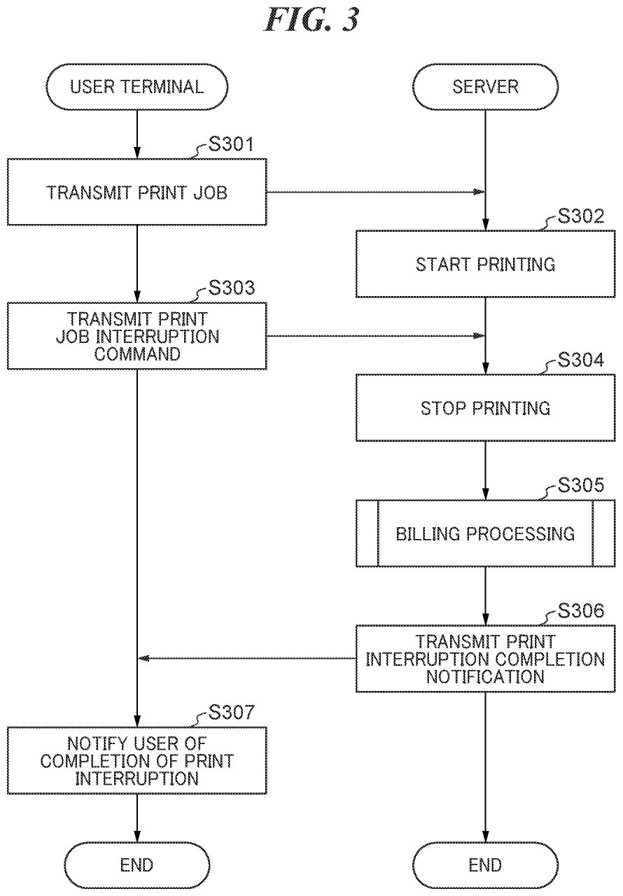

FIG. 3 is a flowchart that shows an operation processing of the server 200 and an operation processing of the user terminal 400 when a user instruction to interrupt a print job is issued according to the first embodiment. The operation processing of the server 200 is executed by the CPU 211 of the server 200 reading out the control program stored in the program memory 213. Similarly, the operation processing of the user terminal 400 is executed by the CPU 411 of the user terminal 400 reading out a control program stored in a program memory 413. In a step S301, when a user instruction for predetermined printing to the printer 100 is inputted on an operation panel 403, the CPU 411 (a job generating unit) of the user terminal 400 generates a print job in response to the user instruction. Thereafter, the CPU 411 transmits the generated print job from the user terminal 400 to the server 200 by using a wireless LAN unit 404 (a job transmitting unit). When the communication control unit 216 (a job receiving unit) receives the print job, the CPU 211 of the server 200 advances the operation processing to a step S302.

In the step S302, the CPU 211 (a print starting unit) of the server 200 transmits the print job transmitted in the step S301 to the printer 100 via the communication control unit 216, and causes the printer 100 to start printing based on the print job.

In a step S303, when a user instruction to interrupt the print job is inputted on the operation panel 403, the CPU 411 (an interruption command generating unit) of the user terminal 400 generates a print job interruption command in response to the user instruction. Thereafter, the CPU 411 transmits the print job interruption command from the user terminal 400 to the server 200 by using the wireless LAN unit 404 (an interruption command transmitting unit). When the communication control unit 216 (an interruption command receiving unit) receives the print job interruption command, the CPU 211 of the server 200 advances the operation processing to a step S304.

In the step S304, the CPU 211 (a print stopping unit) of the server 200 causes the printer 100 to stop the printing started in the step S302, and advances the operation processing to a step S305.

In the step S305, the CPU 211 (a billing setting unit) of the server 200 performs a billing processing. Thereafter, when the billing processing performed in the step S305 is ended, the CPU 211 advances the operation processing to a step S306, transmits a print interruption completion notification from the server 200 to the user terminal 400, and then ends the operation processing. When the CPU 411 of the user terminal 400 receives the print interruption completion notification, the CPU 411 of the user terminal 400 advances the operation processing to a step S307.

In the step S307, the CPU 411 of the user terminal 400 notifies the user that the interruption of the printing has been completed. Specifically, after a notification that indicates “your cancellation of printing has been accepted and the fees for printing performed up to the time of interruption is XX yen” is displayed on the operation panel 403, the CPU 411 of the user terminal 400 ends the operation processing.

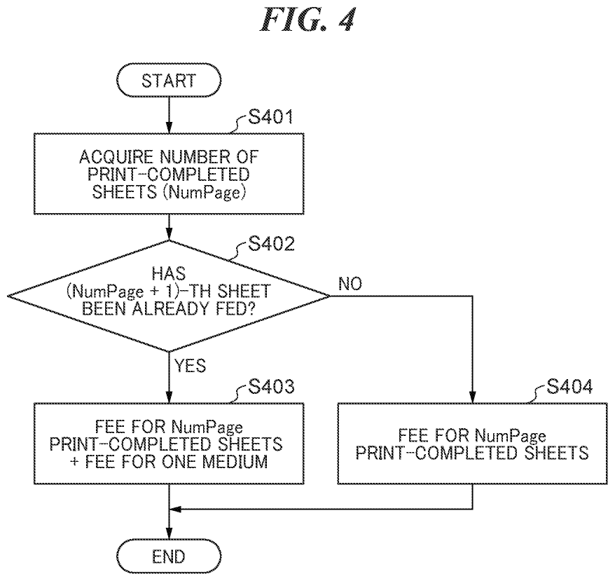

Next, the billing processing at the time of receiving the print job interruption command according to the first embodiment (the billing processing performed in the step S305 of FIG. 3), which is executed in the server 200, will be described with reference to a flowchart of FIG. 4.

The billing processing of the flowchart of FIG. 4 is executed by the CPU 211 of the server 200 reading out the control program stored in the program memory 213.

When the billing processing is started, first, in a step S401, the CPU 211 acquires the number of print-completed sheets, which are printed by the printer 100 during a period from the start of printing in the step S302 to the stop of printing in the step S304, from the printer 100. The number of print-completed sheets acquired in the step S401 is stored in the data memory 214 as NumPage. As described above, the number of print-completed sheets is counted by the CPU 111 (the first counting unit) in the printer 100, and the counting result of the number of print-completed sheets is stored in the data memory 114.

Subsequently, the billing processing proceeds to a step S402, and the CPU 211 determines whether or not the (NumPage+1)-th medium has been fed to the printer 100. This determination is made by acquiring the number of media fed during the period from the start of printing in the step S302 to the stop of printing in the step S304 (the total number of fed sheets) from the printer 100, and comparing the total number of fed sheets with the NumPage acquired in the step S401. As described above, the total number of fed sheets is counted by the CPU 111 (the second counting unit) in the printer 100, and the counting result of the total number of fed sheets is stored in the data memory 114.

In the case that the total number of fed media (the total number of fed sheets) acquired from the printer 100 is (NumPage+1), the CPU 211 determines that there is one medium fed to the printer 100 when the print job interruption command is received, and advances the billing processing to a step S403. On the other hand, in the case that the total number of fed media (the total number of fed sheets) acquired from the printer 100 is NumPage, the CPU 211 determines that there is no medium fed to the printer 100 when the print job interruption command is received, and advances the billing processing to a step S404. In other words, the CPU 211 sets the billing information for the printing based on the interrupted print job in response to the presence or absence of the medium fed to the printer 100 at the time of receiving the print job interruption command.

In the step S403, the CPU 211 sets the billing amount, which is obtained by adding the fee for one medium to the fee for printing of NumPage sheets counted in the step S401 as the billing information and records the billing information (the billing amount) in the data memory 214, and then ends the billing processing. In this case, the print interruption completion notification transmitted to the user terminal 400 in the step S305 includes information indicating that the fee for one medium is additionally billed in addition to the set billing information. In this case, in the step S307 of FIG. 3, the CPU 411 of the user terminal 400 notifies the user of the information indicating that the fee for one medium is additionally billed, which is included in the print interruption completion notification. For example, an additional notification, which indicates “please note that you will be charged (billed) for the fee for a medium that is ejected before or during printing”, is displayed as a caution on the operation panel 403. Furthermore, in the case of proceeding to the step S403, the printer 100 receives the print job interruption command after the medium has been fed, and the medium fed immediately before the printing is stopped is ejected to the outside of the printer 100 in a state before the printing or during the printing. However, in the case that the medium in the state before the printing or during the printing inside the device cannot be ejected to the outside of the printer 100 due to the occurrence of a jam in the printer 100, the fee for one medium may not be billed (charged).

In the step S404, the CPU 211 sets the fee for printing of NumPage sheets counted in the step S401 as the billing information and records the billing information in the data memory 214, and then ends the billing processing. In this case, since there is no medium in the state before the printing or during the printing to be ejected to the outside of the printer 100, of course, the fee for one medium will not be billed (charged).

According to the first embodiment, the server 200 sets the billing information for printing based on the print job in response to a feeding state of the medium in the printer 100 when the printing performed by the printer 100 is stopped in response to the print job interruption command from the user terminal 400. With this configuration, in the case that the user intentionally interrupts the print job by using the user terminal 400, it becomes possible to charge (bill) with respect to the medium before the printing or during the printing, which is ejected to the outside of the printer 100.

Hereinafter, a second embodiment of the present invention will be described. In the second embodiment, the same reference numerals are used for the same components and the same steps as those in the first embodiment, and redundant description will be omitted.

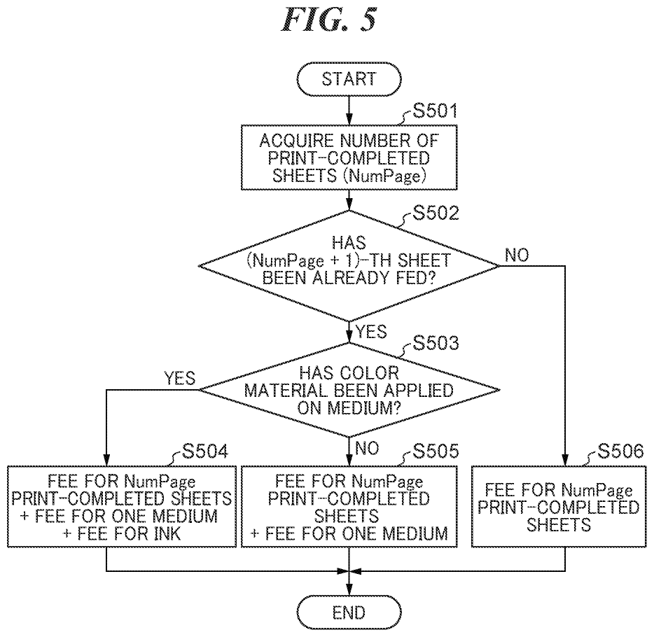

FIG. 5 is a flowchart of the billing processing at the time of receiving the print job interruption command according to the second embodiment (the billing processing performed in the step S305 of FIG. 3), which is executed in the server 200.

The billing processing of the flowchart of FIG. 5 is executed by the CPU 211 of the server 200 reading out the control program stored in the program memory 213.

In the second embodiment, in addition to the configuration of the billing processing (FIG. 4) at the time of receiving the print job interruption command according to the first embodiment, it is characterized in that the amount of a coloring material used is also a billing target. A specific description will be given below.

When the billing processing is started, first, in a step S501, as in the step S401 of FIG. 4, the CPU 211 acquires the number of print-completed sheets from the printer 100, and stores the acquired number of print-completed sheets in the data memory 214 as NumPage.

Subsequently, the billing processing proceeds to a step S502, and as in the step S402 of FIG. 4, the CPU 211 inquires of the printer 100 whether or not the (NumPage+1)-th medium has been fed.

As a result of the inquiry in the step S502, in the case that the (NumPage+1)-th medium has not been fed (NO in the step S502), the billing processing proceeds to a step S506.

In the step S506, as in the step S404 of FIG. 4, the CPU 211 records the fee for printing of NumPage sheets counted in the step S501 in the data memory 214 as the billing information, and then ends the billing processing.

On the other hand, as the result of the inquiry in the step S502, in the case that the (NumPage+1)-th medium has been fed (YES in the step S502), the billing processing proceeds to a step S503.

In the step S503, the CPU 211 determines whether or not the coloring material has been applied on the (NumPage+1)-th medium. When the user intentionally stops the print job, even in the case that the (NumPage+1)-th medium has already been fed to the printer 100, since the (NumPage+1)-th medium is blank if it is before the printing and no coloring material is applied, it is not necessary to charge the coloring material fee. On the other hand, in the case that the coloring material is applied on the (NumPage+1)-th medium, even if the (NumPage+1)-th medium is during the printing, the coloring material fee corresponding to the amount of the coloring material applied on the (NumPage+1)-th medium is calculated as the billing target. For example, in the case that the printer 100 is an inkjet printer, a method of counting the number of ink dots ejected based on the number of input signals to a heater of an inkjet head and converting the number of ink dots into the amount of the coloring material is suitable for the calculation of the amount of the coloring material used.

As a result of the determination in the step S503, in the case that the coloring material has been applied on the (NumPage+1)-th medium (YES in the step S503), the billing processing proceeds to a step S504, and on the other hand, in the case that the coloring material has not been applied on the (NumPage+1)-th medium (NO in the step S503), the billing processing proceeds to a step S505.

In the step S504, the CPU 211 records the billing amount, which is obtained by adding the fee for one medium and the coloring material fee calculated in the step S503 to the fee for printing of NumPage sheets counted in the step S501, in the data memory 214 as the billing information. Thereafter, the CPU 211 ends the billing processing. In this case, in the step S307 of FIG. 3, the CPU 411 of the user terminal 400 notifies the user of information indicating that the fee for one medium and the coloring material fee calculated in the step S503 are additionally billed, which is included in the print interruption completion notification. For example, an additional notification, which indicates “please note that you will be charged (billed) for the fee for a medium that is ejected before or during printing and the fee for the amount of the coloring material used for the medium”, is displayed as a caution on the operation panel 403.

On the other hand, in the case that the billing processing proceeds to the step S505, as in the step S403 of FIG. 4, the CPU 211 records the billing amount, which is obtained by adding the fee for one medium to the fee for printing of NumPage sheets counted in the step S501, in the data memory 214 as the billing information. Thereafter, the CPU 211 ends the billing processing.

According to the second embodiment, in the case that the user intentionally interrupts the print job, in addition to the effects of the first embodiment, it is also possible to charge (bill) the fee for the coloring material actually used.

Hereinafter, a third embodiment of the present invention will be described. In the third embodiment, the same reference numerals are used for the same components and the same steps as those in the first embodiment and the second embodiment, and redundant description will be omitted.

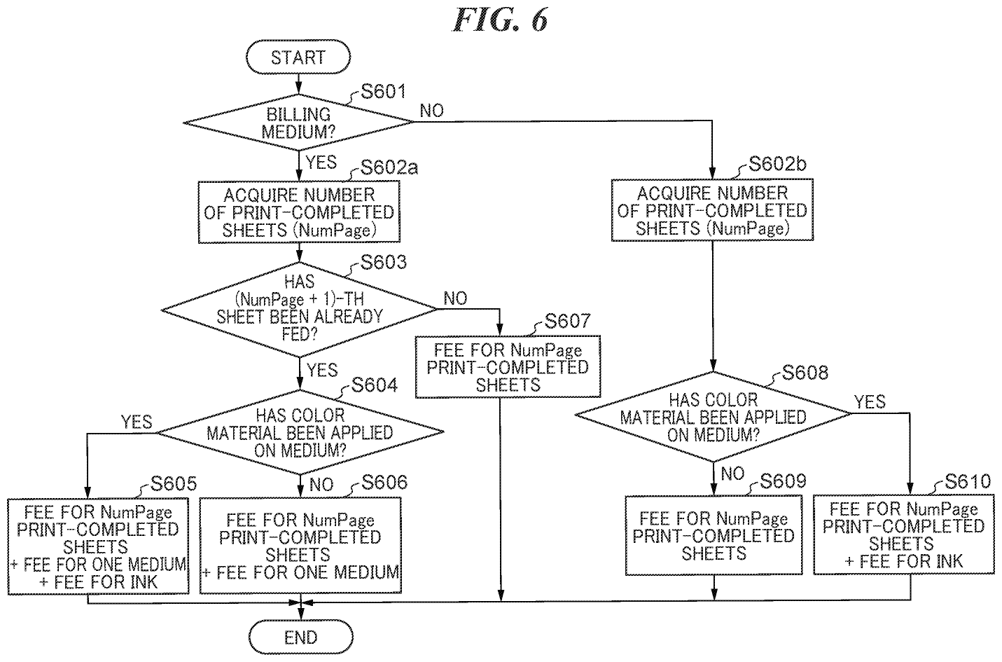

FIG. 6 is a flowchart of the billing processing at the time of receiving the print job interruption command according to the third embodiment (the billing processing performed in the step S305 of FIG. 3), which is executed in the server 200.

The billing processing of the flowchart of FIG. 6 is executed by the CPU 211 of the server 200 reading out the control program stored in the program memory 213.

In the third embodiment, in addition to the configuration of the billing processing (FIG. 5) at the time of receiving the print job interruption command according to the second embodiment, it is characterized in that it is determined whether or not the medium used in the printer 100 is a billing medium. In other words, the configuration of the third embodiment is applicable to a case that the user is able to select whether a printing service vendor (the printing service provider) provides the medium to be used for printing performed by the printer 100 or the user himself/herself prepares the medium to be used for printing performed by the printer 100. A specific description will be given below.

First, in a step S601, it is determined whether or not the medium used in the printer 100 is a billing medium. In other words, it is determined the printing service vendor provides the medium to be used for printing performed by the printer 100 or the user himself/herself prepares the medium to be used for printing performed by the printer 100.

In the case of being determined that the medium used in the printer 100 is the billing medium (a medium being the billing target) (YES in the step S601), the billing processing proceeds to a step S602a, and on the other hand, in the case of being determined that the medium used in the printer 100 is not the billing medium (the medium being the billing target) (NO in the step S601), the billing processing proceeds to a step S602b.

In the step S602a, as in the step S401 of FIG. 4, the CPU 211 acquires the number of print-completed sheets from the printer 100, and stores the acquired number of print-completed sheets in the data memory 214 as NumPage.

Subsequently, the billing processing proceeds to a step S603, and the CPU 211 executes processes similar to the processes after the step S502 of FIG. 5.

On the other hand, in the step S602b, as in the step S401 of FIG. 4, the CPU 211 acquires the number of print-completed sheets from the printer 100, and stores the acquired number of print-completed sheets in the data memory 214 as NumPage.

Since it is determined that the medium used in the printer 100 is not the medium being the billing target, even in the case that the medium before the printing or during the printing is ejected to the outside of the printer 100 at the time of stopping the printing, the medium before the printing or during the printing is originally owned by the user. Therefore, it is not necessary to charge (bill) for the medium, but it is necessary to calculate the coloring material fee corresponding to the amount of the coloring material applied on the medium as the billing target. Therefore, in the third embodiment, after the process of the step S602b, a process similar to the process of the step S402 of FIG. 4 which determines the presence or absence of the medium before the printing or during the printing ejected from the printer 100 at the time of stopping the printing is not performed. However, in the case that the coloring material is used after the printing is stopped, in order to calculate the coloring material fee, after the process of the step S602b, the billing processing proceeds to a step S608.

In the step S608, the CPU 211 determines whether or not the coloring material has been used until the printing is stopped after the printing of the NumPage-th medium is completed. For example, in the case that the printer 100 is the inkjet printer, the CPU 211 determines whether or not ink has been ejected until the printing is stopped after the printing of the NumPage-th medium is completed.

As a result of the determination, in the case that the coloring material has not been used (NO in the step S608), the billing processing proceeds to a step S609, and the CPU 211 records the fee for printing of NumPage sheets (NumPage pieces of media) counted in the step S602a in the data memory 214 as the billing information and then ends the billing processing. Here, the billing amount per sheet in the case that printing is performed on a non-billing medium is generally different from the billing amount per sheet in the case that printing is performed on a billing medium.

On the other hand, as the result of the determination, in the case of being determined that the coloring material has been used (YES in the step S608), the billing processing proceeds to a step S610.

In the step S610, the CPU 211 records the fee for printing of NumPage sheets (NumPage pieces of media) counted in the step S602a and the coloring material fee corresponding to the amount of the coloring material used until the printing is stopped after the printing of the NumPage-th medium is completed in the data memory 214. Thereafter, the CPU 211 ends the billing processing.

It should be noted that each of the embodiments described above can also be realized by a process in which a program that implements one or more functions is supplied to a computer in a system or an apparatus via a network or a storage medium, and a system control unit of the system or the apparatus reads out and executes the program. The system control unit may have one or a plurality of processors or circuits, and may include a network of a plurality of separate system control units, or a network of a plurality of separate processors or circuits in order to read out and execute executable instructions.

The processor or the circuit may include a central processing unit (CPU), a micro processing unit (MPU), a graphics processing unit (GPU), an application specific integrated circuit (ASIC), or a field programmable gate array (FPGA). In addition, the processor or the circuit may include a digital signal processor (DSP), a data flow processor (DFP), or a neural processing unit (NPU).

### Other Embodiments

Embodiment(s) of the present invention can also be realized by a computer of a system or apparatus that reads out and executes computer executable instructions (e.g., one or more programs) recorded on a storage medium (which may also be referred to more fully as anon-transitory computer-readable storage medium′) to perform the functions of one or more of the above-described embodiment(s) and/or that includes one or more circuits (e.g., ASIC) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-172538, filed on Oct. 27, 2022, which is hereby incorporated by reference herein in its entirety.

What is claimed is:

1. A billing control apparatus that is communicably connected to a user terminal and an image printing apparatus and manages billing information related to printing performed by the image printing apparatus based on a print job instructed by a user via the user terminal, the billing control apparatus comprising:
a job receiving unit configured to receive the print job from the user terminal;
an interruption command receiving unit configured to receive an interruption command of the print job instructed by the user from the user terminal; and
a controller configured or programmed to function as:
a print starting unit that transmits the received print job to the image printing apparatus and causes the image printing apparatus to start printing based on the print job;
a print stopping unit that causes the image printing apparatus to stop the printing upon receiving the interruption command from the user terminal; and
a billing setting unit that sets billing information related to the printing based on a feeding state of a medium in the image printing apparatus when the printing performed by the image printing apparatus is stopped by the print stopping unit.

2. The billing control apparatus according to claim 1, wherein
the image printing apparatus comprises a controller configured or programmed to function as:
a printing unit that, upon receiving the print job from the billing control apparatus, performs control so as to sequentially feed a medium to an inner part of the image printing apparatus and print an image on the fed medium;
a first counting unit that counts NumPage, which is a number of pieces of media on which printing of the image has been completed, after the printing unit starts the printing; and
a second counting unit that counts a total number of pieces of media fed to the inner part of the image printing apparatus until the printing is stopped by the print stopping unit after the printing unit starts the printing, and
the billing setting unit acquires counting results obtained by the first counting unit and the second counting unit and, in a case that the total number is NumPage+1, includes a fee for one medium in the billing information.

3. The billing control apparatus according to claim 2, wherein
in a case that a coloring material has been applied on the one medium, the billing setting unit calculates a coloring material amount of the applied coloring material and includes a fee for the coloring material calculated based on the calculated coloring material amount in the billing information.

4. The billing control apparatus according to claim 3, wherein
in the case that the coloring material has been applied on the one medium, the billing setting unit causes the user terminal to display that the fee for the coloring material amount used for the one medium is included in the billing information.

5. The billing control apparatus according to claim 2, wherein
in a case that the one medium is owned by the user, the billing setting unit does not include the fee for the one medium in the billing information.

6. The billing control apparatus according to claim 2, wherein
in a case that the one medium is not ejected due to occurrence of a jam in the inner part of the image printing apparatus, the billing setting unit does not include the fee for the one medium in the billing information.

7. The billing control apparatus according to claim 2, wherein
in a case that the fee for the one medium is included in the billing information, the billing setting unit causes the user terminal to display that the fee for the one medium is included in the billing information.

8. A billing system comprising:
a user terminal;
an image printing apparatus; and
a billing control apparatus that is communicably connected to the user terminal and the image printing apparatus and manages billing information related to printing performed by the image printing apparatus based on a print job instructed by a user via the user terminal, and
wherein
the user terminal comprises
a controller configured or programmed to function as:
a job generating unit that generates the print job based on a user instruction; and
an interruption command generating unit that generates an interruption command of the print job based on a user instruction;
a job transmitting unit that transmits the print job to the billing control apparatus; and
an interruption command transmitting unit that transmits the interruption command to the billing control apparatus, and
the billing control apparatus comprises a controller configured or programmed to function as:
a print starting unit that, in a case of receiving the print job from the user terminal, transmits the print job to the image printing apparatus and causes the image printing apparatus to start printing based on the print job;
a print stopping unit that, in a case of receiving the interruption command from the user terminal, causes the image printing apparatus to stop the printing; and
a billing setting unit that sets billing information related to the printing based on a feeding state of a medium when the printing performed by the image printing apparatus is stopped by the print stopping unit.

9. A control method for a billing control apparatus that is communicably connected to a user terminal and an image printing apparatus and manages billing information related to printing performed by the image printing apparatus based on a print job instructed by a user via the user terminal,
the control method comprising:
a job receiving step of receiving the print job from the user terminal;
an interruption command receiving step of receiving an interruption command of the print job instructed by the user from the user terminal;
a print starting step of transmitting the received print job to the image printing apparatus and causes the image printing apparatus to start printing based on the print job;
a print stopping step of causing the image printing apparatus to stop the printing upon receiving the interruption command from the user terminal; and
a billing setting step of setting billing information related to the printing based on a feeding state of a medium in the image printing apparatus when the printing performed by the image printing apparatus is stopped in the print stopping step.

10. A control method for a billing system that comprises a user terminal, an image printing apparatus, and a billing control apparatus that is communicably connected to the user terminal and the image printing apparatus and manages billing information related to printing performed by the image printing apparatus based on a print job instructed by a user via the user terminal, the control method comprising:
a job generating step, in the user terminal, of generating the print job based on a user instruction;
a job transmitting step, in the user terminal, of transmitting the print job to the billing control apparatus;
an interruption command generating step, in the user terminal, of generating an interruption command of the print job based on a user instruction;
an interruption command transmitting step, in the user terminal, of transmitting the interruption command to the billing control apparatus;
a print starting step, in the billing control apparatus, of transmitting the print job to the image printing apparatus in a case of receiving the print job from the user terminal, and causing the image printing apparatus to start printing based on the print job;
a print stopping step, in the billing control apparatus, of causing the image printing apparatus to stop the printing in a case of receiving the interruption command from the user terminal; and
a billing setting step, in the billing control apparatus, of setting billing information related to the printing based on a feeding state of a medium when the printing performed by the image printing apparatus is stopped in the print stopping step.

11. A non-transitory computer-readable storage medium storing a program for causing a computer to execute a control method for a billing control apparatus that is communicably connected to a user terminal and an image printing apparatus and manages billing information related to printing performed by the image printing apparatus based on a print job instructed by a user via the user terminal,
the control method comprising:
a job receiving step of receiving the print job from the user terminal;
an interruption command receiving step of receiving an interruption command of the print job instructed by the user from the user terminal;
a print starting step of transmitting the received print job to the image printing apparatus and causes the image printing apparatus to start printing based on the print job;
a print stopping step of causing the image printing apparatus to stop the printing upon receiving the interruption command from the user terminal; and
a billing setting step of setting billing information related to the printing based on a feeding state of a medium in the image printing apparatus when the printing performed by the image printing apparatus is stopped in the print stopping step.

12. A non-transitory computer-readable storage medium storing a program for causing a computer to execute a control method for a billing system that comprises a user terminal, an image printing apparatus, and a billing control apparatus that is communicably connected to the user terminal and the image printing apparatus and manages billing information related to printing performed by the image printing apparatus based on a print job instructed by a user via the user terminal,
the control method comprising:
a job generating step, in the user terminal, of generating the print job based on a user instruction;
a job transmitting step, in the user terminal, of transmitting the print job to the billing control apparatus;
an interruption command generating step, in the user terminal, of generating an interruption command of the print job based on a user instruction;
an interruption command transmitting step, in the user terminal, of transmitting the interruption command to the billing control apparatus;
a print starting step, in the billing control apparatus, of transmitting the print job to the image printing apparatus in a case of receiving the print job from the user terminal, and causing the image printing apparatus to start printing based on the print job;
a print stopping step, in the billing control apparatus, of causing the image printing apparatus to stop the printing in a case of receiving the interruption command from the user terminal; and
a billing setting step, in the billing control apparatus, of setting billing information related to the printing based on a feeding state of a medium when the printing performed by the image printing apparatus is stopped in the print stopping step.
